(19) United States
(12) Patent Application Publication
(10) Pub. No.: US 2017/0053098 A1
(43) Pub. Date: Feb. 23, 2017

(54) SYSTEMS AND METHODS FOR DISPENSING CONTROLLED MEDICINES

(71) Applicants: Spencer Hawkins, Chattanooga, TN (US); Ming Jiang, Alpharetta, GA (US)

(72) Inventors: Spencer Hawkins, Chattanooga, TN (US); Ming Jiang, Alpharetta, GA (US)

(21) Appl. No.: 14/831,851

(22) Filed: Aug. 20, 2015

(51) Int. Cl. G06F 19/00; G05B 15/02; H04W 4/00

(52) U.S. Cl. CPC G06F 19/3462; H04W 4/008; G05B 15/02

(57) ABSTRACT

A controlled medicine dispensing system may include: a controlled medicine dispensing mechanism, a dispenser locking mechanism, a touch-screen display and control device, a communication controller, and a controlled medicine dispensing controller. Controlled medicine dispensing controller includes at least one processor, and a memory storing computer executable instructions, when executed by the processor, the computer executable instructions cause the processor to perform: receiving a personal identification number from a user, the user being a patient or a pharmacist, through the touch-screen display and control device, authenticating the user, allowing the pharmacist to open the dispenser locking mechanism to refill one or more controlled medicines according to a prescription by a patient's physician when the user is the pharmacist, and providing at least one controlled medicine to the patient through the controlled medicine dispensing mechanism during one or more predetermined time windows when the user is the patient.

### FIELD

The present disclosure relates generally to medication dispensing, and more particularly to systems and methods for dispensing certain controlled medicines.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is a paradox of modern medicine that treatments which have the ability to alleviate pain and suffering hold the potential to be misused and abused. When a physician prescribes a patient a remedy, there is a certain trust and expectation that the patient will use their medication safely as prescribed. This traditional system of dispensing medications is affordable and appropriate for most patients. However, there are certain high risk groups of patients who may benefit from a different approach.

Chronic pain patients often require high doses of narcotic pain medication. When used as directed, opiate pain relievers can be a safe and effective treatment for a variety of pain conditions. According to the Center for Disease Control and Prevention, since 1999, the number of prescriptions written by physicians for opiate based pain killers has quadrupled. Over the same time period the number of overdose death rates has nearly paralleled this increase in number of prescriptions. Physicians are increasingly reluctant to prescribe opiate pain medication due to issues of dependence and abuse. Physicians that do prescribe narcotics often impose strict opiate contracts in an attempt to enforce safe medication practices, but these rules often fall short in preventing deaths from overdose.

Alternatively, psychiatrists often encounter patients with reduced insight into their own mental disorders. These patients may not fully understand the importance of their medication and the potential for misuse. For example, suicidal patients require treatment with antidepressants. Relatively safe medications such as selective serotonin reuptake inhibitors (SSRIs) are commonly indicated, but in refractory cases, tricyclic antidepressants (TCAs) may be necessary. TCAs, while effective in treating depression, carry the risk of fatal cardiac arrhythmias in the event of an overdose. It is current practice to discharge recently suicidal patients with vital medications that can unfortunately also be used for a subsequent attempt on their life. Psychiatry is also plagued with issues of medication adherence. Many patients with chronic disorders such as bipolar and dementia forget to take their medication. Concerned family members and physicians have no way of monitoring how often a loved one is taking their medication. It is desirable to have a medication dispenser that allows a patient access to high risk medications at appropriate times and dosage as directed by their physician.

Therefore, an unaddressed need exists in the art to address the aforementioned deficiencies and inadequacies.

### SUMMARY

In one aspect, the present disclosure related to a controlled medicine dispensing system. In certain embodiments, the controlled medicine dispensing system includes: a controlled medicine dispensing mechanism, a dispenser locking mechanism, a touch-screen display and control device, a communication controller, and a controlled medicine dispensing controller. The controlled medicine dispensing mechanism is used to dispense one or more controlled medicines according to a prescription by a patient's physician. The dispenser locking mechanism is used to prevent the patient from accessing the one or more controlled medicines outside of certain predetermined time windows according to the prescription. The touch-screen display and control device allows the patient access to one or more controlled medicines during one of the predetermined time windows according to the prescription, and a pharmacist to refill the one or more controlled medicines. The communication controller is used to communicate with a controlled medicine management system through a communication network. The controlled medicine dispensing controller includes at least one processor, and a memory storing firmware.

In certain embodiments, when the firmware stored in the memory is executed by the processor, the firmware is configured to: (a) establish communication between the controlled medicine dispensing system and the controlled medicine management system through the communication network, (b) register, at the controlled medicine management system through the communication network, certain number of users, wherein the users comprise at least one patient as a primary user of the controlled medicine dispensing system, one or more physicians for prescribing one or more controlled medicines for the patient, and one more pharmacists for fill the prescriptions for the patient, (c) receive a personal identification number (PIN) from a user, the user being the patient or the one of the one or more pharmacists, through the touch-screen display and control device, (d) authenticate the user, (e) allow the pharmacist to refill the one or more controlled medicines according to the prescription by the patient's physician, when the user is the pharmacist, and (f) provide the one or more controlled medicines to the patient through the controlled medicine dispensing mechanism during one of the predetermined time windows, when the user is the patient.

In certain embodiments, the communication network includes one or more of: the internet, a Wi-Fi network, a local area network (LAN), a wide area network (WAN), a wireless communication network, a land line communication network, and a personal area network (PAN). The PAN further includes wireless universal serial bus (USB), Bluetooth, Zigbee, Body Area Network (BAN), and Near Field Communication (NFC) network.

In certain embodiments, when the user is the pharmacist, the firmware is configured to perform one or more of following operations: (a) retrieving the patient's prescription from the controlled medicine management system through the communication network, (b) unlocking the controlled medicine dispensing system at the pharmacist's unlocking request to allow the pharmacist to refill the patient's prescription retrieved, (c) updating a controlled medicine inventory in the controlled medicine dispensing system, and (d) locking the controlled medicine dispensing system.

When the user is the patient, the firmware is configured to perform one or more of following operations: (a) determining whether the current time is within one of the predetermined time windows according to the prescription, and (b) when the current time is within one of the predetermined time windows, performing one or more of following operations, (c) providing the patient with the one or more controlled medicines through the controlled medicine dispensing mechanism according to the prescription, (d) updating the controlled medicine inventory in the controlled medicine dispensing system, (e) determining whether the last dose of the one or more controlled medicines in the controlled medicine inventory has been dispensed, and (f) notifying the patient and the physician through the controlled medicine management system for prescription refill over the communication network, when the last dose of the one or more controlled medicines in the controlled medicine inventory has been dispensed.

In certain embodiments, the firmware includes: an operating system, a communication interface module, a user interface module, a timing module, and a dispenser control module. The operating system manages and controls the operations of the controlled medicine dispensing system. The communication interface module maintain communication between the controlled medicine dispensing system and the controlled medicine management system to retrieve the prescription, and request controlled medicine refill through the communication controller and the communication network. The user interface module has a multi touch interface and a display interface module. The multi touch interface receives input from the user, and the display interface module displays the user interface as well as user interface information to the user. The timing module keeps the time, and stores the predetermined time windows according to the prescription. The dispenser control module controls the dispenser locking mechanism, and the medicine dispensing mechanism.

In certain embodiments, the touch-screen display and control device includes: a multi-touch display and control module, a display controller, and a multi-touch controller. The multi-touch display and control module receives multi-touch input from the user and displays information received from the user interface module. The display controller receives display information from the display interface module of the user interface module, and displays the information received on the multi-touch display and control module. The multi-touch controller receives user input through the multi-touch display and control module, and transmit the received user input to the multi-touch interface module of the user interface module.

In certain embodiments, the controlled medicine dispensing system has: a top cylindrical container body, and a lower cylindrical container body. The top cylindrical container body has a closed top end, and an open bottom end. The lower cylindrical container body has an open top end that is lockable and connected to the open lower end of the top cylindrical container body, and a closed bottom end. The touch-screen display and control device is installed on the closed top end of the top cylindrical container body to allow the user to input information and see the information display. The controlled medicine dispensing controller, the dispenser locking mechanism, and the communication controller are installed inside the top cylindrical container body. The medicine dispensing mechanism is installed in the lower cylindrical container body, for dispensing the one or more controlled medicines through a medicine outlet.

In certain embodiments, the controlled medicine dispensing system also includes a power source, a power switch, and at least one operation status indicator. The power switch controls the power to the controlled medicine dispensing system. The at least operation status indicator configured to display the power status, the operation status, and network connection status of the controlled medicine dispensing system. In certain embodiments, the at least one operation status indicator is a multi-color light emitting diode (LED). The operation status indicator displays following colors: (a) when the power is connected and the controlled medicine dispensing system is turned off, the operation status indicator displays red color; (b) when the controlled medicine dispensing system is turned on and the communication controller is connected to an operational communication network, the operation status indicator displays green color; and (c) when the controlled medicine dispensing system is turned on and the communication controller is not connected to an operational communication network, the operation status indicator displays yellow color.

In certain embodiments, the controlled medicine dispensing system includes a time window indicator. The time window indicator is used to indicate whether the current time falls into one of several predetermined time windows. In one embodiment, the time window indicator is a dual-color LED. When the current time falls into one of several predetermined time windows, the time window indicator displays green color. When the current time does not fall into one of several predetermined time windows, the time window indicator displays red color.

In another aspect, the present disclosure relates to a computer-implemented method for dispensing one or more controlled medicines by using a controlled medicine dispensing system. In certain embodiments, a computer-implemented method includes one or more of following operations: (a) establishing communication between the controlled medicine dispensing system and a controlled medicine management system through a communication network, (b) registering, at the controlled medicine management system through the communication network, certain number of users, wherein the users comprise at least one patient as a primary user of the controlled medicine dispensing system, one or more physicians for prescribing one or more controlled medicines for the patient, and one more pharmacists for fill the prescriptions for the patient, (c) receiving a personal identification number (PIN) from a user, the user being the patient or one of the one or more pharmacists, through a touch-screen display and control device of the controlled medicine dispensing system from the user, (d) authenticating the user through the PIN received, (e) determining whether the authenticated user is the patient or one of the one or more pharmacists. When the user is one of the one or more pharmacists, the computer-implemented method includes one or more of following operations: (f) retrieving a prescription for the patient from a patient's physician from the controlled medicine management system through the communication network, (g) unlocking the controlled medicine dispensing system at the pharmacist's unlocking request, (h) allowing the pharmacist to refill the one or more controlled medicines into the controlled medicine dispensing system according to the prescription retrieved, (i) updating a controlled medicine inventory of the one or more controlled medicines of the controlled medicine dispensing system, and (j) locking the controlled medicine dispensing system at the pharmacist's locking request when the refill is completed. When the user is the patient, the computer-implemented method includes one or more of following operations: (k) determining whether the current time falls into one of several predetermined time windows for the patient to take the one or more controlled medicines according to the prescription, (l) providing no controlled medicines when the current time does not fall into one of several predetermined time windows for the patient to take the one or more controlled medicines, (m) providing a dose of the one or more controlled medicines when the current time falls into one of several predetermined time windows for the patient to take the one or more controlled medicines according to the prescription, (n) updating a controlled medicine inventory of the one or more controlled medicines of the controlled medicine dispensing system, (o) determining whether the last dose of the one or more controlled medicines has been provided to the patient, and (p) notifying the patient and the patient's physician through the controlled medicine management system for refill.

In certain embodiments, the controlled medicine dispensing system includes: a controlled medicine dispensing mechanism, a dispenser locking mechanism, the touch-screen display and control device, a communication controller, and a controlled medicine dispensing controller. The controlled medicine dispensing mechanism is used to dispense one or more controlled medicines according to a prescription by a patient's physician. The dispenser locking mechanism is used to prevent the patient from accessing the one or more controlled medicines outside of certain predetermined time windows according to the prescription. The touch-screen display and control device allows the patient to access the one or more controlled medicines during one of the predetermined time windows according to the prescription, and a pharmacist to refill the one or more controlled medicines. The communication controller is used to communicate with the controlled medicine management system through the communication network. The controlled medicine dispensing controller includes at one processor, and a memory storing firmware.

In certain embodiments, the firmware includes: an operating system, a communication interface module, a user interface module, a timing module, and a dispenser control module. The operating system manages and controls the operations of the controlled medicine dispensing system. The communication interface module maintain communication between the controlled medicine dispensing system and the controlled medicine management system to retrieve the prescription, and request controlled medicine refill through the communication controller and the communication network. The user interface module has a multi touch interface and a display interface module. The multi touch interface receives input from the user, and the display interface module displays the user interface as well as user interface information to the user. The timing module keeps the time, and stores the predetermined time windows according to the prescription. The dispenser control module controls the dispenser locking mechanism, and the medicine dispensing mechanism.

In certain embodiments, the touch-screen display and control device includes: a multi-touch display and control module, a display controller, and a multi-touch controller. The multi-touch display and control module receives multi-touch input from the user and displays information received from the user interface module. The display controller receives display information from the display interface module of the user interface module, and displays the information received on the multi-touch display and control module. The multi-touch controller receives user input through the multi-touch display and control module, and transmit the received user input to the multi-touch interface module of the user interface module.

In certain embodiments, the controlled medicine dispensing system has: a top cylindrical container body, and a lower cylindrical container body. The top cylindrical container body has a closed top end, and an open bottom end. The lower cylindrical container body has an open top end that is locakably connected to the open lower end of the top cylindrical container body, and a closed bottom end. The touch-screen display and control device is installed on the closed top end of the top cylindrical container body to allow the user to input information and see the information display. The controlled medicine dispensing controller, the dispenser locking mechanism, and the communication controller are installed inside the top cylindrical container body. The medicine dispensing mechanism is installed in the lower cylindrical container body, for dispensing the one or more controlled medicines through a medicine outlet.

In certain embodiments, the controlled medicine dispensing system also includes a power source, a power switch, and at least one operation status indicator. The power switch controls the power to the controlled medicine dispensing system. The at least one operation status indicator configured to display the power status, the operation status, and network connection status of the controlled medicine dispensing system. In certain embodiments, the at least one operation status indicator is a multi-color light emitting diode (LED). The operation status indicator displays following colors: (a) when the power is connected and the controlled medicine dispensing system is turned off, the operation status indicator displays red color; (b) when the controlled medicine dispensing system is turned on and the communication controller is connected to an operational communication network, the operation status indicator displays green color; and (c) when the controlled medicine dispensing system is turned on and the communication controller is not connected to an operational communication network, the operation status indicator displays yellow color.

In yet another aspect, the present disclosure relates to a non-transitory computer storage medium. The non-transitory computer storage medium stores computer-executable instructions. When these computer-executable instructions is executed by a processor of a controlled medicine dispensing controller of a controlled medicine dispensing system, cause the processor to perform one or more of following operations of dispensing one or more controlled medicines: (a) establishing communication between the controlled medicine dispensing system and a controlled medicine management system through a communication network, (b) registering, at the controlled medicine management system through the communication network, certain number of users, wherein the users comprise at least one patient as a primary user of the controlled medicine dispensing system, one or more physicians for prescribing one or more controlled medicines for the patient, and one more pharmacists for fill the prescriptions for the patient, (c) receiving a personal identification number (PIN) from a user, the user being the patient or one of the one or more pharmacists, through a touch-screen display and control device of the controlled medicine dispensing system from the user, (d) authenticating the user through the PIN received, (e) determining whether the authenticated user is the patient or one of the one or more pharmacists. When the user is the pharmacist, the computer-implemented method includes one or more of following operations: (f) retrieving a prescription for the patient from a patient's physician from the controlled medicine management system through the communication network, (g) unlocking the controlled medicine dispensing system at the pharmacist's unlocking request, (h) allowing the pharmacist to refill the one or more controlled medicines into the controlled medicine dispensing system according to the prescription retrieved, (i) updating a controlled medicine inventory of the one or more controlled medicines of the controlled medicine dispensing system, and (j) locking the controlled medicine dispensing system at the pharmacist's locking request when the refill is completed. When the user is the patient, the computer-implemented method includes one or more of following operations: (k) determining whether the current time falls into one of several predetermined time windows for the patient to take the one or more controlled medicines according to the prescription, (l) providing no controlled medicines when the current time does not fall into one of several predetermined time windows for the patient to take the one or more controlled medicines, (m) providing a dose of the one or more controlled medicines when the current time falls into one of several predetermined time windows for the patient to take the one or more controlled medicines according to the prescription, (n) updating a controlled medicine inventory of the one or more controlled medicines of the controlled medicine dispensing system, (o) determining whether the last dose of the one or more controlled medicines has been provided to the patient, and (p) notifying the patient and the patient's physician through the controlled medicine management system for refill.

In certain embodiments, the controlled medicine dispensing system includes: a controlled medicine dispensing mechanism, a dispenser locking mechanism, the touch-screen display and control device, a communication controller, and a controlled medicine dispensing controller. The controlled medicine dispensing mechanism is used to dispense one or more controlled medicines according to a prescription by a patient's physician. The dispenser locking mechanism is used to prevent the patient from accessing the one or more controlled medicines outside of certain predetermined time windows according to the prescription. The touch-screen display and control device allows the patient to access the one or more controlled medicines during one of the predetermined time windows according to the prescription, and a pharmacist to refill the one or more controlled medicines. The communication controller is used to communicate with the controlled medicine management system through the communication network. The controlled medicine dispensing controller includes at least one processor, and a memory storing firmware.

In certain embodiments, the firmware includes: an operating system, a communication interface module, a user interface module, a timing module, and a dispenser control module. The operating system manages and controls the operations of the controlled medicine dispensing system. The communication interface module maintain communication between the controlled medicine dispensing system and the controlled medicine management system to retrieve the prescription, and request controlled medicine refill through the communication controller and the communication network. The user interface module has a multi touch interface and a display interface module. The multi touch interface receives input from the user, and the display module displays the user interface as well as user interface information to the user. The timing module keeps the time, and stores the predetermined time windows according to the prescription. The dispenser control module controls the dispenser locking mechanism, and the medicine dispensing mechanism.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings FIGS. 1-3. These accompanying drawings illustrate one or more embodiments of the present disclosure and, together with the written description, serve to explain the principles of the present disclosure. Wherever possible, the same reference numbers are used throughout the drawings to refer to the same or like elements of an embodiment, and wherein:

FIG. 1 schematically depicts a controlled medicine dispensing system according to certain embodiments of the present disclosure;

FIG. 2 shows a block diagram of a management and control system of the controlled medicine dispensing system according to certain embodiments of the present disclosure; and

FIG. 3 shows a flowchart of the operation of the management and control system of the controller medicine dispensing system according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, the term “controlled medicine” may refer to any kind of medicine prescribed by a physician, and accidental overdose of which may cause death, or serious harm to a patient.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The terms “chip” or “computer chip”, as used herein, generally refer to a hardware electronic component, and may refer to or include a small electronic circuit unit, also known as an integrated circuit (IC), or a combination of electronic circuits or ICs.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

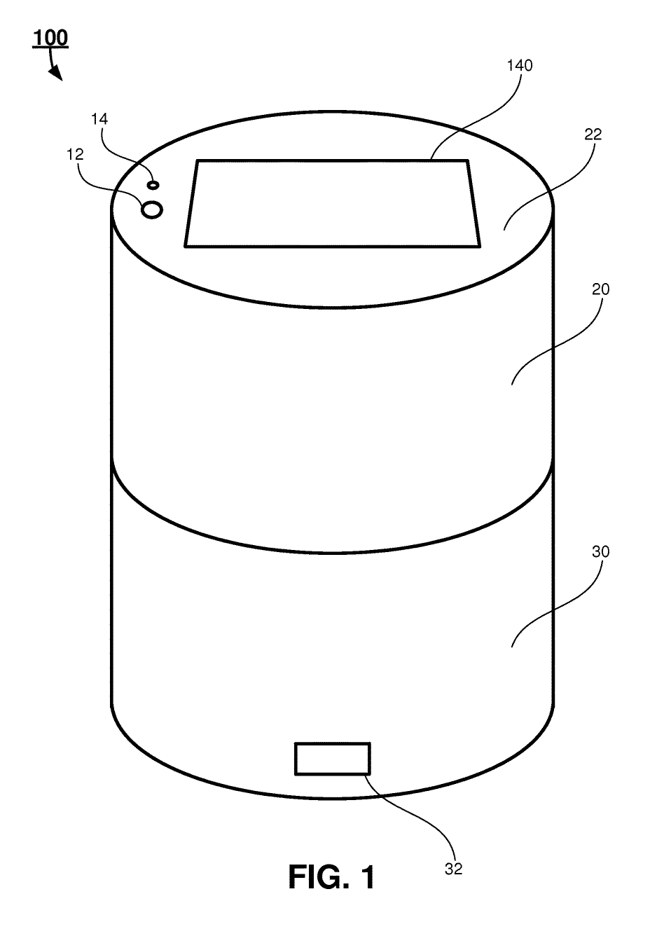

The present disclosure will now be described more fully hereinafter with reference to the accompanying drawings, FIGS. 1-3, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

In one aspect, the present invention related to a controlled medicine dispensing system 100 according to certain embodiments of the present disclosure, as shown in FIG. 1. In certain embodiments, the controlled medicine dispensing system 100 has: a top cylindrical container body 20, and a lower cylindrical container body 30. The top cylindrical container body 20 has a closed top end 22, and an open bottom end. The lower cylindrical container body 30 has an open top end that is locakably connected to the open lower end of the top cylindrical container body 20, and a closed bottom end. The connected top cylindrical container body 20 and the lower cylindrical container body 30 form a controlled medicine dispensing system body.

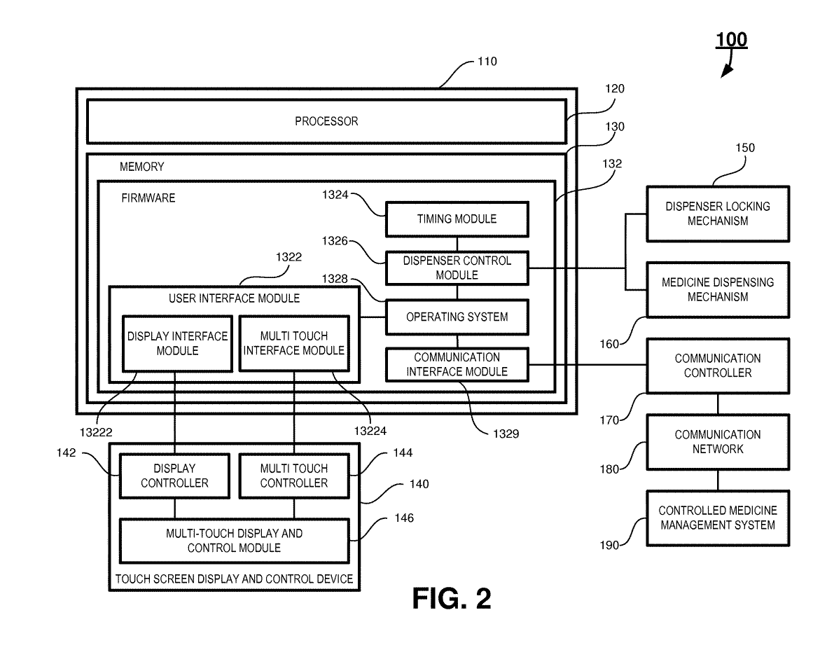

Referring now to FIG. 2, a block diagram of a management and control system of the controlled medicine dispensing system 100 is shown according to certain embodiments of the present disclosure. The management and control system of the controlled medicine dispensing system 100 is installed inside of the controlled medicine dispensing system body. In certain embodiments, the management and control system of the controlled medicine dispensing system 100 includes a touch-screen display and control device 140, a controlled medicine dispensing controller 110, a dispenser locking mechanism 150, a communication controller 170, and a medicine dispensing mechanism 160.

The controlled medicine dispensing mechanism 160 is used to dispense one or more controlled medicines according to a prescription by a patient's physician. The dispenser locking mechanism 150 is used to prevent the patient from accessing the one or more controlled medicines outside of certain predetermined time windows according to the prescription. The touch-screen display and control device 140 allows the patient to access the one or more controlled medicines during one of the predetermined time windows according to the prescription, and a pharmacist to refill the one or more controlled medicines. The communication controller 170 is used to communicate with a controlled medicine management system 190 through a communication network 180. The controlled medicine dispensing controller 110 includes at least one processor 120, and a memory 130 storing firmware 132.

In certain embodiments, the controlled medicine dispensing system 100 has: a top rectangular container body 20 (not shown in FIG. 1), and a lower rectangular container body 30 (not shown in FIG. 1). The top rectangular container body 20 has a closed top end 22, and an open bottom end. The lower rectangular container body 30 has an open top end that is locakably connected to the open lower end of the top rectangular container body 20, and a closed bottom end. The connected top rectangular container body 20 and the lower rectangular container body 30 form a controlled medicine dispensing system body. The management and control system of the controlled medicine dispensing system 100 is installed inside of the controlled medicine dispensing system body.

In certain embodiments, the top cylindrical or rectangular container body 20, and a lower cylindrical or rectangular container body 30 are made of strong materials such as stainless steel to prevent anyone from tempering the controlled medicine dispensing system 100, and unauthorized accessing the controlled medicines inside of the top cylindrical or rectangular container body 20, and the lower cylindrical or rectangular container body 30.

In one embodiment, the top cylindrical or rectangular container body 20, and the lower cylindrical or rectangular container body 30 may contain a coating designed for prescription labels to be stuck on and removed easily. In another embodiment, prescription labels may be displayed on the touch screen display and control device 140 on the top surface of the body of the controlled medicine dispensing system 100, and the prescription labels may be updated electronically. In yet another embodiment, an organic light emitting diode (OLED) that can be bent to fit on curved surface may be utilized to display the prescription labels on the side of the body of the controlled medicine dispensing system 100. Such prescription labels may also be updated electronically.

In certain embodiments, the touch-screen display and control device 140 is installed on the top surface of the closed top end 22 of the top cylindrical container body 20, allowing the user to input information and receive information via the display. The controlled medicine dispensing controller 110, the dispenser locking mechanism 150, and the communication controller 170 are installed inside the top cylindrical container body 20. The medicine dispensing mechanism 160 is installed in the lower cylindrical container body 30, for dispensing one or more controlled medicines through a medicine outlet 32. The controlled medicine dispensing controller 110, and the communication controller 170 will be described in detail in following sections.

In certain embodiments, the dispenser locking mechanism 150 includes two or more pairs of matching blocks, and a motorized locking mechanism. Each pair of the matching blocks includes a first block positioned at the open bottom end of the top cylindrical container body 20, having a first hole near the center of the first block, and a second block positioned at the open top end of the lower cylindrical container body 30, having a second hole near the center of the second block. The two or more pairs of the matching blocks are positioned substantially equal distance from each other. When the open bottom end of the top cylindrical container body 20 is placed on the open top end of the lower cylindrical container body 30, and the top cylindrical container body 20 is turned about 10 to 15 degrees, a first block at the open bottom end of the top cylindrical container body 20 will be placed under a corresponding second block at the open top end of the lower cylindrical container body 30. In one embodiment, the locking mechanism includes one motorized locking pin to be inserted into the first hole of the first block and the second hole of the corresponding second block. In another embodiments, the mechanism includes one motorized locking pin for each of the two or more pairs of matching blocks to be inserted into each of the first hole of the first block and the second hole of the corresponding second block, respectively. The one or more motorized pins prevent the rotation of the top cylindrical container body 20, i.e., moving horizontally, and the placement of the first block under the second block prevent the top cylindrical container body 20 moving vertically, therefore, locking the controlled medicine dispensing system body.

In certain embodiments, the medicine dispensing mechanism 160 is designed according to the capacity of the controlled medicine dispensing system 100, and actual size of the controlled medicine to be dispensed. The medicine dispensing mechanism 160 includes one or more layers of motorized carousel shaped medicine dispensing assembly. According to Food and Drug Administration (FDA) regulations, for controlled medicines in Schedules 2, 3 and 4 are valid for only 28 days. Therefore, in one embodiment, the capacity of the controlled medicine dispensing system 100 is for a prescription for 4 weeks (28 days) and three times a day. In another embodiment, the capacity of the controlled medicine dispensing system 100 is for a prescription for 2 weeks (14 days) and twice a day. In yet another embodiment, the medicine dispensing mechanism 160 is flexibly configured to dispense controlled medicine for a prescription upto four weeks (28 days) and four times a day. In this embodiment, the medicine dispensing mechanism 160 includes two layers of the motorized carousel shaped medicine dispensing assemblies, each layer of the motorized carousel shaped medicine dispensing assembly includes 14 individual compartments, one for each day. Each of the 14 individual compartments is divided into four different sub compartments, one for each dose of the day. Each sub compartment is filled with one dose of the controlled medicine. The motorized carousel shaped medicine dispensing assembly rotates approximately 26 degrees each day to provide controlled medicine of the day. Each individual compartment has at least three sub compartment dividers, each of them can be individually controlled. The bottom of the individual compartment may be formed such that the inside of the individual compartment is higher than the outside of the individual compartment, and once the sub compartment divider is lifted, the controlled medicine can be dispensed by its gravity.

In another embodiment, where the controlled medicine dispensing system body has the top rectangular container body 20 and the lower rectangular container body 30, the medicine dispensing mechanism 160 is configured in a matrix form having a total of 28×4=112 individual compartments. The bottom of each of the individual compartment includes an individually controllable panel. When the controlled medicine in a particular individual compartment is scheduled to be released to a patient, the individual controllable panel of the particular individual compartment is open and the controlled medicine in the individual compartment is therefore released to the patient. Other configurations of the medicine dispensing mechanism 160 are also possible and will not be discussed here in detail.

In certain embodiments, the controlled medicine dispensing system 100 also includes a power source, a power switch 12, and at least one operation status indicator 14. In certain embodiment, the power source includes a household electricity, battery, and rechargeable battery. In one embodiment, the power source is a combination of household electricity, battery, and rechargeable battery. When the controlled medicine dispensing system 100 is used at the patient's home, it may be plugged into the wall electric outlet. When the controlled medicine dispensing system 100 is brought to the pharmacy for refill, it uses the battery or rechargeable battery inside as power source. The power switch 12 controls the power to the controlled medicine dispensing system 100. At least one operation status indicator 14 is configured to display the power status, the operation status, and network connection status of the controlled medicine dispensing system 100. In certain embodiments, the at least one operation status indicator 14 is a multi-color light emitting diode (LED). The operation status indicator 14 displays following colors: (a) when the power is connected and the controlled medicine dispensing system 100 is turned off, the operation status indicator 14 displays red color; (b) when the controlled medicine dispensing system 100 is turned on and the communication controller 170 is connected to an operational communication network 180, the operation status indicator 14 displays green color; and (c) when the controlled medicine dispensing system 100 is turned on and the communication controller 170 is not connected to an operational communication network 180, the operation status indicator 14 displays yellow color.

In certain embodiments, the controlled medicine dispensing system 100 includes a time window indicator 16. The time window indicator 16 is used to indicate whether the current time falls into one of several predetermined time windows for the patient to take the controlled medicine stored in the controlled medicine dispensing system 100. In one embodiment, the time window indicator 16 is a dual-color LED. When the current time falls into one of several predetermined time windows, the time window indicator 16 displays green color. When the current time does not fall into one of several predetermined time windows, the time window indicator 16 displays red color. In another embodiment, the time window indicator 16 is a single-color LED. When the current time falls into one of several predetermined time windows, the time window indicator 16 flashes or is turned on. When the current time does not fall into one of several predetermined time windows, the time window indicator 16 does not flash, or is turned off.

In certain embodiments, when the firmware 132 stored in the memory 130 is executed by the processor 120, the firmware 132 is configured to:
(a) establish communication between the controlled medicine dispensing system and the controlled medicine management system through the communication network;
(b) register, at the controlled medicine management system through the communication network, certain number of users, wherein users include a patient as a primary user of the controlled medicine dispensing system, one or more physicians for prescribing one or more controlled medicines for the patient, and one more pharmacists for fill the prescriptions for the patient. The pharmacist provides the controller medicine dispensing system 100 as well as one or more controlled medicines to the patient. In certain embodiments, the pharmacist performs the registration on the controller medicine dispensing system 100 through its user interface. The registration includes, but not limited to: the model and the serial number of the controller medicine dispensing system 100, the patient's name, address and other contact information, the contact information of the one or more pharmacists, the contact information of one or more physicians for the patient, usernames and personal identification number (PIN) of the patient, the pharmacists, and the physicians, the capacity of the controller medicine dispensing system 100 etc. Once the registration is completed, the controller medicine dispensing system 100 is ready for the pharmacist to fill the one or more controlled medicines.
(c) receive a personal identification number (PIN) from a user, the user being the patient or one of the one or more pharmacists, through the touch-screen display and control device 140;
(d) authenticate the user;
(e) allow the pharmacist to refill the one or more controlled medicines according to the prescription by the patient's physician, when the user is the pharmacist, and
(f) provide the one or more controlled medicines to the patient through the controlled medicine dispensing mechanism 160 during the predetermined time windows, when the user is the patient.

In certain embodiments, when the user is the pharmacist, the firmware 132 is configured to perform one or more of following operations:
(a) retrieving the patient's prescription from the controlled medicine management system 190 through the communication network 180;
(b) unlocking the controlled medicine dispensing system 100 at the pharmacist's unlocking request to allow the pharmacist to refill the patient's prescription retrieved;
(c) updating a controlled medicine inventory in the controlled medicine dispensing system 100; and
(d) locking the controlled medicine dispensing system 100.

When the user is the patient, the firmware 132 is configured to perform one or more of following operations:
(a) determining whether the current time is within one of the predetermined time windows according to the prescription; and
(b) when the current time is within one of the predetermined time windows, performing one or more of following operations;
(c) providing the patient with the one or more controlled medicines through the controlled medicine dispensing mechanism 160 according to the prescription;
(d) updating the controlled medicine inventory in the controlled medicine dispensing system 100;
(e) determining whether the last dose of the one or more controlled medicines in the controlled medicine inventory has been dispensed; and
(f) notifying the patient and the physician through the controlled medicine management system 190 for prescription refill over the communication network 180, when the last dose of the one or more controlled medicines in the controlled medicine inventory has been dispensed.

In certain embodiments, as shown in FIG. 2, the firmware 132 includes: an operating system 1328, a communication interface module 1329, a user interface module 1322, a timing module 1324, and a dispenser control module 1326. The operating system 1328 manages and controls the operations of the controlled medicine dispensing system 100. The communication interface module 1329 maintain communication between the controlled medicine dispensing system 100 and the controlled medicine management system 190 to retrieve the prescription, and request controlled medicine refill through the communication controller 170 and the communication network 180. The user interface module 1322 has a multi touch interface 13224 and a display interface module 13222. The multi touch interface 13224 receives input from the user, and the display interface module 13222 displays the user interface as well as user interface information to the user. The timing module 1324 keeps the time, and stores the predetermined time windows according to the prescription. The dispenser control module 1326 controls the dispenser locking mechanism 150, and the medicine dispensing mechanism 160.

In certain embodiments, the touch-screen display and control device 140 includes: a multi-touch display and control module 146, a display controller 142, and a multi-touch controller 144. The multi-touch display and control module 146 receives multi-touch input from the user and displays information received from the user interface module 1322. The display controller 142 receives display information from the display module 13222 of the user interface module 1322, and displays the information received on the multi-touch display and control module 146. The multi-touch controller 144 receives user input through the multi-touch display and control module 146, and transmit the received user input to the multi-touch interface module 13224 of the user interface module 1322.

In certain embodiments, the communication network 180 includes one or more of: the internet, a Wi-Fi network, a local area network (LAN), a wide area network (WAN), a wireless communication network, a land line communication network, and a personal area network (PAN).

In one embodiment, the controlled medicine dispensing system 100 includes a Wi-Fi network interface to connect to the Wi-Fi network. In another embodiment, the controlled medicine dispensing system 100 includes a CAT-5 cable interface to connect to the LAN and WAN. In yet another embodiment, the controlled medicine dispensing system 100 includes wireless communication interface to connect to the wireless communication network. In a further embodiment, the controlled medicine dispensing system 100 includes a universal serial bus (USB) interface to connect to a computer that has communication network connected.

In certain embodiments, the controlled medicine dispensing system 100 may be used by the patient without the connection to the communication network 180. Therefore, when the patient does not have internet connection, wireless communication network, or the Wi-Fi network at home, the controlled medicine dispensing system 100 may be used as a stand-alone unit that does not have connection to the communication network 180. In this case, when the patient is notified, through the touch screen display and control device 140, that the last dose has been dispensed and the controlled medicines must be refilled, the patient has to take the controlled medicine dispensing system 100 to a designated pharmacy to refill. The pharmacist at the pharmacy may connect the controlled medicine dispensing system 100 through its USB interface to the computer that has the connection to the communication network 180 to refill the one or more controlled medicines.

In certain embodiments, the PAN further includes wireless universal serial bus (USB), Bluetooth, Zigbee, Body Area Network (BAN), and Near Field Communication (NFC) network.

In another aspect, the present invention relates to a computer-implemented method for dispensing one or more controlled medicines by using a controlled medicine dispensing system 100. In certain embodiments, the computer-implemented method includes one or more of following operations:
(a) establishing communication between the controlled medicine dispensing system 100 and a controlled medicine management system 190 through a communication network 180;
(b) registering, at the controlled medicine management system through the communication network, certain number of users, wherein the users comprise at least one patient as a primary user of the controlled medicine dispensing system, one or more physicians for prescribing one or more controlled medicines for the patient, and one more pharmacists for fill the prescriptions for the patient;
(c) receiving a personal identification number (PIN) from a user, the user being a patient or a pharmacist, through a touch-screen display and control device 140 of the controlled medicine dispensing system 100 from the user;
(d) authenticating the user through the PIN received; and
(e) determining whether the authenticated user is the patient or the pharmacist.

When the user is the pharmacist, the computer-implemented method includes one or more of following operations:
(f) retrieving a prescription for the patient from a patient's physician from the controlled medicine management system 190 through the communication network 180;
(g) unlocking the controlled medicine dispensing system 100 at a pharmacist's unlocking request;
(h) allowing the pharmacist to refill the one or more controlled medicines into the controlled medicine dispensing system 100 according to the prescription retrieved;
(i) updating a controlled medicine inventory of the one or more controlled medicines of the controlled medicine dispensing system 100; and
(j) locking the controlled medicine dispensing system 100 at a pharmacist's locking request when the refill is completed.

When the user is the patient, the computer-implemented method includes one or more of following operations:
(k) determining whether the current time falls into one of several predetermined time windows for the patient to take the one or more controlled medicines according to the prescription;
(l) providing no controlled medicines when the current time does not fall into one of several predetermined time windows for the patient to take the one or more controlled medicines;
(m) providing a dose of the one or more controlled medicines when the current time falls into one of several predetermined time windows for the patient to take the one or more controlled medicines according to the prescription;
(n) updating a controlled medicine inventory of the one or more controlled medicines of the controlled medicine dispensing system 100;
(o) determining whether the last dose of the one or more controlled medicines has been provided to the patient; and
(p) notifying the patient and the patient's physician through the controlled medicine management system 190 for refill.

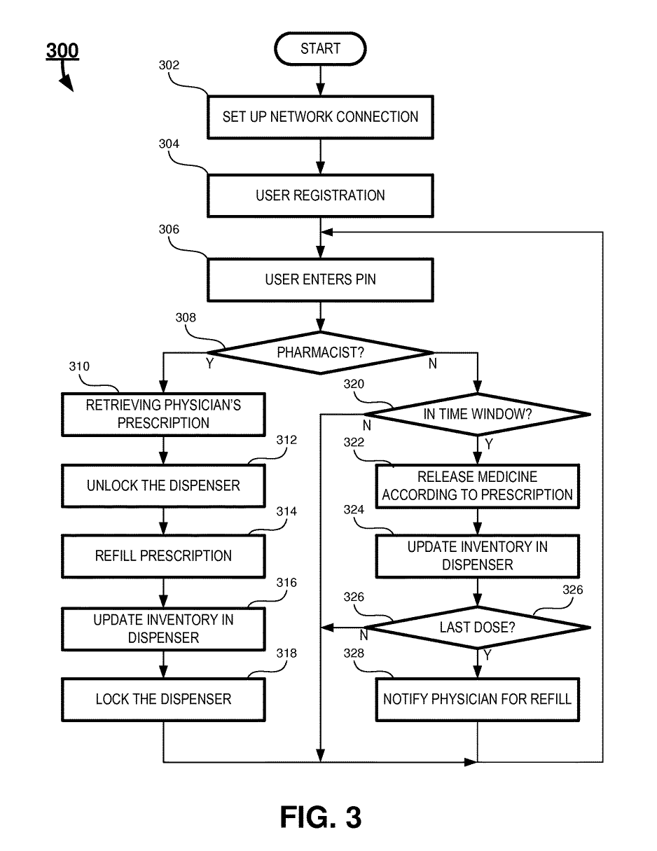

Referring now to FIG. 3, a flowchart of the operation of a management and control system of a controller medicine dispensing system 100 is shown according to certain embodiments of the present disclosure. The controller medicine dispensing system 100 is primarily used by either a patient who is taking one or more controlled medicines prescribed by his/her physician, and a pharmacist who provides and refills the one or more controlled medicines.

At operation 302 after the start, the controller medicine dispensing system 100 first establishes a network connection between the controller medicine dispensing system 100 and a controlled medicine management system 190;

At operation 304, a user registers the controller medicine dispensing system 100 with the controlled medicine management system 190. The user may be one of one or more pharmacists, or a patient. The controller medicine dispensing system 100 is used primarily by the patient. The pharmacist provides the controller medicine dispensing system 100 as well as one or more controlled medicines to the patient. In certain embodiments, the pharmacist performs the registration on the controller medicine dispensing system 100 through its user interface. The registration includes, but not limited to: the model and the serial number of the controller medicine dispensing system 100, the patient's name, address and other contact information, the contact information of the one or more pharmacists, the contact information of one or more physicians for the patient, usernames and personal identification number (PIN) of the patient, the pharmacists, and the physicians, the capacity of the controller medicine dispensing system 100 etc. Once the registration is completed, the controller medicine dispensing system 100 is ready for the pharmacist to fill the one or more controlled medicines.

At operation 306, a user enters his/her personal identification number (PIN). The user can be either the patient or the patient's pharmacist.

At operation 308, the management and control system of the controller medicine dispensing system 100 determines whether the user is the patient or the pharmacist. When the user is the pharmacist, the operation continues to operation 310. Otherwise, when the user is the patient, the operation continues to operation 320.

At operation 310, the management and control system of the controller medicine dispensing system 100 retrieves a prescription by the patient's physician through a controlled medicine management system 190. When the physician prescribe one or more controlled medicines to the patient to take, the prescription is transmitted to the controlled medicine management system 190. When the pharmacist provides or refill the controlled medicines to the patient, the pharmacist retrieves the prescription by the patient's physician through the controlled medicine management system 190. In certain embodiments, the prescription includes the name of the patient, the names of the one or more controlled medicines, the number of times a day the patient takes the controlled medicines, the quantity of controlled medicines for the patient to take each time, several predetermined time windows the patient can take the controlled medicines, and any precaution the patient should be informed etc. A touch screen display and control device 140 displays the prescription information on a multi-touch display and control module 146 to the pharmacist.

At operation 312, the pharmacist unlocks and opens the controller medicine dispensing system 100;

At operation 314, the pharmacist refills the controlled medicines according to the prescription displayed on the touch screen display and control device 140.

At operation 316, the pharmacist updates an inventory of the controlled medicines of the controller medicine dispensing system 100 on the touch screen display and control device 140.

At operation 318, the pharmacist locks the controller medicine dispensing system 100 and hand over the controller medicine dispensing system 100 to the patient to conclude the refill process.

At operation 320, when the user is the patient, the controller medicine dispensing system 100 determines whether the current time falls into one of several predetermined time windows. If the current time does not fall into one of several predetermined time windows, the operation of taking controlled medicine is end, not allowing the patient to take the controlled medicines at this time. Otherwise, when the current time falls into one of several predetermined time windows, the operation of taking controlled medicine is continued to operation 322.

At operation 322, the controller medicine dispensing system 100 dispenses one or more controlled medicines through a medicine outlet 32 and provides the one or more controlled medicines to the patient so that the patient can take it at this time.

At operation 324, the controller medicine dispensing system 100 updates the inventory of the controlled medicines of the controller medicine dispensing system 100 and display the current inventory on the touch screen display and control device 140.

At operation 326, the controller medicine dispensing system 100 determines whether the last dose of the controlled medicines is dispensed, or the inventory of the controlled medicines reaches a certain threshold the required refill of the controlled medicine based on the current inventory of the controlled medicines of the controller medicine dispensing system 100. When sufficient amount of the controlled medicines remains in the controller medicine dispensing system 100, the operation ends. When the last dose is taken by the patient, and there is no more controlled medicines left, or the inventory of the controlled medicines reaches the certain threshold, the operation continues to operation 328.

At operation 328, the controller medicine dispensing system 100 notifies the patient's physician for refill through the controlled medicine management system 190 over the communication network 180. The physician can provide refill instructions to the controlled medicine management system 190 to update or modify the prescription, or continue the prescription as before. The operation of the patient taking controlled medicines ends.

In yet another aspect, the present invention relates to a non-transitory computer storage medium. The non-transitory computer storage medium stores computer-executable instructions. When these computer-executable instructions is executed by a processor 120 of a controlled medicine dispensing controller 110 of a controlled medicine dispensing system 100, cause the processor 120 to perform one or more of following operations of dispensing one or more controlled medicines:
(a) establishing communication between the controlled medicine dispensing system 100 and a controlled medicine management system 190 through a communication network 180;
(b) registering, at the controlled medicine management system through the communication network, certain number of users, wherein the users include a patient as a primary user of the controlled medicine dispensing system, one or more physicians for prescribing one or more controlled medicines for the patient, and one more pharmacists for fill the prescriptions for the patient;
(c) receiving a personal identification number (PIN) from a user, the user being a patient or a pharmacist, through a touch-screen display and control device 140 of the controlled medicine dispensing system 100 from the user;
(d) authenticating the user through the PIN received; and
(e) determining whether the authenticated user is the patient or the pharmacist.

When the user is the pharmacist, the computer-implemented method includes one or more of following operations:
(f) retrieving a prescription for the patient from a patient's physician from the controlled medicine management system 190 through the communication network 180;
(g) unlocking the controlled medicine dispensing system 100 at a pharmacist's unlocking request;
(h) allowing the pharmacist to refill the one or more controlled medicines into the controlled medicine dispensing system 100 according to the prescription retrieved;
(i) updating a controlled medicine inventory of the one or more controlled medicines of the controlled medicine dispensing system 100; and
(j) locking the controlled medicine dispensing system 100 at a pharmacist's locking request when the refill is completed.

When the user is the patient, the computer-implemented method includes one or more of following operations:
(k) determining whether the current time falls into one of several predetermined time windows for the patient to take the one or more controlled medicines according to the prescription;
(l) providing no controlled medicines when the current time does not fall into one of several predetermined time windows for the patient to take the one or more controlled medicines;
(m) providing a dose of the one or more controlled medicines when the current time falls into one of several predetermined time windows for the patient to take the one or more controlled medicines according to the prescription;
(n) updating a controlled medicine inventory of the one or more controlled medicines of the controlled medicine dispensing system 100;
(o) determining whether the last dose of the one or more controlled medicines has been provided to the patient; and
(p) notifying the patient and the patient's physician through the controlled medicine management system 190 for refill.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1. A controlled medicine dispensing system comprising:
a controlled medicine dispensing mechanism configured to dispense one or more controlled medicines to a patient according to a prescription by a physician of the patient;
a dispenser locking mechanism configured to prevent the patient from accessing the one or more controlled medicines outside of a plurality of predetermined time windows according to the prescription;
a touch-screen display and control device configured to allow the patient to access the one or more controlled medicines during one of the plurality of predetermined time windows according to the prescription, and a pharmacist to open the dispenser locking mechanism to refill the one or more controlled medicines according to the prescription;
a communication controller configured to communicate with a controlled medicine management system through a communication network to report current inventory of the controlled medicine and request refill according to the prescription;
a controlled medicine dispensing controller having at least one processor, and a memory storing computer executable instructions, when executed by the processor, the computer executable instructions cause the processor to perform:
registering, via the controlled medicine dispensing system through the communication network with the controlled medicine management system, a plurality of users, wherein the plurality of users comprises at least one patient, one or more physicians for providing prescription of the controlled medicines and one or more pharmacists for refilling the controlled medicines according to the prescription;
receiving a personal identification number (PIN) from a user through the touch-screen display and control device;
authenticating, by the controlled medicine dispensing system through the controlled medicine management system, the user using the PIN received;
allowing the pharmacist to open the dispenser locking mechanism to refill the one or more controlled medicines according to the prescription by the physician, when the user is the pharmacist; and
providing the one or more controlled medicines to the patient through the controlled medicine dispensing mechanism during the plurality of predetermined time windows according to the prescription, when the user is the patient.

2. The controlled medicine dispensing system according to claim 1, wherein the communication network comprises:
the internet;
a Wi-Fi network;
a local area network (LAN);
a wide area network (WAN);
a personal area network (PAN) having wireless universal serial bus (USB), Bluetooth, Zigbee, Body Area Network (BAN), and Near Field Communication (NFC) network;
a wireless communication network; and
a land line communication network.

3. The controlled medicine dispensing system according to claim 2, wherein the computer executable instructions cause the processor to perform one or more of following operations, when the user is the pharmacist:
retrieving the prescription from the controlled medicine management system through the communication network;
unlocking the controlled medicine dispensing system at the user's unlocking request to allow the pharmacist to refill the prescription retrieved;
updating a controlled medicine inventory in the controlled medicine dispensing system; and
locking the controlled medicine dispensing system.

4. The controlled medicine dispensing system according to claim 3, wherein the computer executable instructions cause the processor to perform one or more of following operations, when the user is the pharmacist:
determining whether the current time is within the plurality of predetermined time windows according to the prescription; and
performing following operations, when the current time is within one of the plurality of predetermined time windows:
providing the patient with the controlled medicine through the controlled medicine dispensing mechanism according to the prescription;
updating the controlled medicine inventory in the controlled medicine dispensing system;
determining whether the last dose of the one or more controlled medicine in the controlled medicine inventory has been dispensed; and
notifying the patient and the physician through the controlled medicine management system for prescription refill through the communication network, when the last dose of the one or more controlled medicine in the controlled medicine inventory has been dispensed.

5. The controlled medicine dispensing system according to claim 4, wherein the computer executable instructions comprise:
an operating system configured to manage and control the operations of the controlled medicine dispensing system;
a communication interface module configured to communicate with the controlled medicine management system to retrieve the prescription, and request controlled medicine refill through the communication controller and the communication network;
a user interface module having a multi touch interface configured to receive input from the user, and a display interface module configured to display the user interface to the user;
a timing module configured to keep the time, and store the plurality of predetermined time windows according to the prescription; and
a dispenser control module configured to control the dispenser locking mechanism, and the medicine dispensing mechanism.

6. The controlled medicine dispensing system according to claim 1, wherein the touch-screen display and control device comprises:
a multi-touch display and control module configured to receive multi-touch input from the user and display information received from the user interface module;
a display controller configured to receive display information from the display interface module of the user interface module, and display the information received on the multi-touch display and control module; and
a multi-touch controller configured to receive user input through the multi-touch display and control module, and transmit the received user input to a multi-touch interface module of the user interface module.

7. The controlled medicine dispensing system according to claim 6, further comprises:
a top cylindrical container body having a closed top end, and an open bottom end; and
a lower cylindrical container body having an open top end that is locakably connected to the open lower end of the top cylindrical container body, and a closed bottom end,
wherein the touch-screen display and control device is installed on the closed top end of the top cylindrical container body to allow the user to input information and see the information display, the controlled medicine dispensing controller, the dispenser locking mechanism, and the communication controller are installed inside the top cylindrical container body, the medicine dispensing mechanism is installed in the lower cylindrical container body, for dispensing the one or more controlled medicines through a medicine outlet.

8. The controlled medicine dispensing system according to claim 7, further comprises:
a power source;
a power switch configured to control the power to the controlled medicine dispensing system; and
at least one operation status indicator configured to display the power and operation status of the controlled medicine dispensing system.

9. The controlled medicine dispensing system according to claim 8, wherein the at least one operation status indicator comprises a multi-color light emitting diode (LED), wherein
the operation status indicator displays red color when the power is connected and the controlled medicine dispensing system is turned off;
the operation status indicator displays green color when the controlled medicine dispensing system is turned on and the communication controller is connected to an operational communication network; and
the operation status indicator displays yellow color when the controlled medicine dispensing system is turned on and the communication controller is not connected to an operational communication network.

10. The controlled medicine dispensing system according to claim 9, further comprises a time window indicator configured to indicate whether the current time falls into one of the plurality of predetermined time windows, wherein the time window indicator comprises a dual-color LED, wherein
the time window indicator displays green color when the current time falls into one of the plurality of predetermined time windows; and
the time window indicator displays red color when the current time does not fall into one of the plurality of predetermined time windows.

11. A computer-implemented method for dispensing one or more controlled medicines by using a controlled medicine dispensing system, comprising one or more of following operations:
establishing, by the controlled medicine dispensing system, communication between the controlled medicine dispensing system and a controlled medicine management system through a communication network to report current inventory of the controlled medicine and request refill according to a prescription from a physician of a patient;
registering, via the controlled medicine dispensing system through the communication network with the controlled medicine management system, a plurality of users, wherein the plurality of users comprises at least one patient, one or more physicians for providing prescription of the controlled medicines and one or more pharmacists for refilling the controlled medicines according to the prescription;
receiving, by the controlled medicine dispensing system, a personal identification number (PIN) from a user through a touch-screen display and control device of the controlled medicine dispensing system from the user;
authenticating, by the controlled medicine dispensing system through the controlled medicine management system, the user using the PIN received;
determining whether the authenticated user is the patient or the pharmacist;
performing, by the controlled medicine dispensing system, one or more of following operations when the user is the pharmacist:
retrieving a prescription for the patient from the physician from the controlled medicine management system through the communication network;
unlocking the controlled medicine dispensing system at a pharmacist's unlocking request;
allowing the pharmacist to refill the one or more controlled medicines into the controlled medicine dispensing system according to the prescription retrieved;
updating a controlled medicine inventory of the one or more controlled medicines of the controlled medicine dispensing system; and
locking the controlled medicine dispensing system at a pharmacist's locking request when the refill is completed; and
performing, by the controlled medicine dispensing system, one or more of following operations, when the user is the patient:
determining whether the current time falls into one of a plurality of predetermined time windows for the patient to take the one or more controlled medicines according to the prescription;
providing no controlled medicines when the current time does not fall into one of the plurality of predetermined time windows for the patient to take the one or more controlled medicines;
providing a dose of the one or more controlled medicines when the current time falls into one of the plurality of predetermined time windows for the patient to take the one or more controlled medicines according to the prescription;
updating a controlled medicine inventory of the one or more controlled medicines of the controlled medicine dispensing system;
determining whether the last dose of the one or more controlled medicine has been provided to the patient; and
notifying the patient and the physician through the controlled medicine management system for refill.

12. The computer-implemented method of claim 11, wherein the controlled medicine dispensing system comprises:
a controlled medicine dispensing mechanism configured to dispense the one or more controlled medicines to the patient according to the prescription;
a dispenser locking mechanism configured to prevent the patient from accessing the one or more controlled medicines outside of the plurality of predetermined time windows according to the prescription;
the touch-screen display and control device configured to allow the patient to access the one or more controlled medicines during one of the plurality of predetermined time windows, and a pharmacist to open the dispenser locking mechanism to refill the one or more controlled medicines, according to the prescription;
a communication controller configured to communicate with the controlled medicine management system through the communication network; and
a controlled medicine dispensing controller having at least one processor, a memory storing computer executable instructions to be executed by the at least one processor.

13. The computer-implemented method of claim 12, wherein the computer executable instructions comprise:
an operating system configured to manage and control the operations of the controlled medicine dispensing system;
a communication interface module configured to communicate with the controlled medicine management system through the communication network to retrieve the prescription, and request refill of the one or more controlled medicines through the communication controller and the communication network;
a user interface module having a multi touch interface configured to receive input from the user, and a display interface module configured to display the user interface to the user;
a timing module configured to keep the time, and store the plurality of predetermined time windows according to the prescription; and
a dispenser control module configured to control the dispenser locking mechanism, and the medicine dispensing mechanism.

14. The computer-implemented method of claim 13, wherein the touch-screen display and control device comprises:
a multi-touch display and control module configured to receive multi-touch input from the user and display information received from the user interface module;
a display controller configured to receive display information from the display interface module of the user interface module, and display the information received on the multi-touch display and control module; and
a multi-touch controller configured to receive user input through the multi-touch display and control module, and transmit the received user input to a multi-touch interface module of the user interface module.

15. The computer-implemented method of claim 12, wherein the controlled medicine dispensing system comprises:
a top cylindrical container body having a closed top end, and an open bottom end; and
a lower cylindrical container body having an open top end that is locakably connected to the open lower end of the top cylindrical container body, and a closed bottom end,
wherein the touch-screen display and control device is installed on the closed top end of the top cylindrical container body to allow the user to input information and see the information display, the controlled medicine dispensing controller, the dispenser locking mechanism, and the communication controller are installed inside the top cylindrical container body, the medicine dispensing mechanism is installed in the lower cylindrical container body, for dispensing the one or more controlled medicines through a medicine outlet.

16. The computer-implemented method of claim 15, wherein the controlled medicine dispensing system further comprises:
a power source;
a power switch configured to control the power to the controlled medicine dispensing system; and
at least one operation status indicator configured to display the power and operation status of the controlled medicine dispensing system.

17. The computer-implemented method of claim 16, wherein the at least one operation status indicator comprises a multi-color light emitting diode (LED), wherein
the operation status indicator displays red color when the power is connected and the controlled medicine dispensing system is turned off;
the operation status indicator displays green color when the controlled medicine dispensing system is turned on and the communication controller is connected to an operational communication network; and
the operation status indicator displays yellow color when the controlled medicine dispensing system is turned on and the communication controller is not connected to an operational communication network.

18. A non-transitory computer storage medium having computer-executable instructions stored thereon which, when executed by a processor of a controlled medicine dispensing controller of a controlled medicine dispensing system, cause the processor to perform one or more of following operations of dispensing one or more controlled medicines:
establishing, by the controlled medicine dispensing system, communication between the controlled medicine dispensing system and a controlled medicine management system through a communication network to report current inventory of the controlled medicine and request refill according to a prescription from a physician of a patient;
registering, via the controlled medicine dispensing system through the communication network with the controlled medicine management system, a plurality of users, wherein the plurality of users comprises at least one patient, one or more physicians for providing prescription of the controlled medicines and one or more pharmacists for refilling the controlled medicines according to the prescription;
receiving, by the controlled medicine dispensing system, a personal identification number (PIN) from a user through a touch-screen display and control device of the controlled medicine dispensing system from a user;
authenticating, by the controlled medicine dispensing system through the controlled medicine management system, the user using the PIN received;
determining, by the controlled medicine dispensing system, whether the authenticated user is the patient or the pharmacist;
performing, by the controlled medicine dispensing system, one or more of following operations when the user is the pharmacist:
retrieving the prescription for the patient from the physician from the controlled medicine management system through the communication network;
unlocking the controlled medicine dispensing system at a pharmacist's unlocking request;
allowing the pharmacist to refill the one or more controlled medicines into the controlled medicine dispensing system according to the prescription retrieved;
updating a controlled medicine inventory of the one or more controlled medicines of the controlled medicine dispensing system; and
locking the controlled medicine dispensing system at a pharmacist's locking request when the refill is completed; and
performing, by the controlled medicine dispensing system, one or more of following operations, when the user is the patient:
determining whether the current time falls into one of a plurality of predetermined time windows for the patient to take the one or more controlled medicines according to the prescription;
providing no controlled medicines when the current time does not fall into one of the plurality of predetermined time windows for the patient to take the one or more controlled medicines;
providing a dose of the one or more controlled medicines when the current time falls into one of the plurality of predetermined time windows for the patient to take the one or more controlled medicines according to the prescription;
updating a controlled medicine inventory of the one or more controlled medicines of the controlled medicine dispensing system;
determining whether the last dose of the one or more controlled medicine has been provided to the patient; and
notifying the patient and the physician through the controlled medicine management system for refill.

19. The non-transitory computer storage medium of claim 18, wherein the controlled medicine dispensing system comprises:
a controlled medicine dispensing mechanism configured to dispense the one or more controlled medicines to a patient according to the prescription;
a dispenser locking mechanism configured to prevent the patient from accessing the one or more controlled medicines outside of the plurality of predetermined time windows according to the prescription;
the touch-screen display and control device configured to allow the patient to access the one or more controlled medicines during one of the plurality of predetermined time windows, and a pharmacist to open the dispenser locking mechanism to refill the one or more controlled medicines, according to the prescription;
a communication controller configured to communicate with the controlled medicine management system through the communication network; and
the controlled medicine dispensing controller having the processor, a memory storing the computer executable instructions to be executed by the at least one processor.

20. The non-transitory computer storage medium of claim 19, wherein the firmware further comprises:
an operating system configured to manage and control the operations of the controlled medicine dispensing system;
a communication interface module configured to communicate with the controlled medicine management system through the communication network to retrieve the prescription, and request refill of the one or more controlled medicines through the communication controller and the communication network;
a user interface module having a multi touch interface configured to receive input from the user, and a display interface module configured to display the user interface to the user;
a timing module configured to keep the time, and store the plurality of predetermined time windows according to the prescription; and
a dispenser control module configured to control the dispenser locking mechanism, and the medicine dispensing mechanism.
